(19) United States
(12) Patent Application Publication
(10) Pub. No.: US 2009/0134223 A1
(43) Pub. Date: May 28, 2009

(54) Card Holder-Reader for Wallet Sized Cards

(76) Inventors: Richard Peter Matthews, Peterborough (CA); Todd Paleczny, Heidelberg (CA); Michel Georges Quinlan, Peterborough (CA)

Correspondence Address: Richard Matthews, P.O. Box 2131, Peterborough, ON, K9J7Y4, omitted

(21) Appl. No.: 12/269,026

(22) Filed: Nov. 11, 2008

Related U.S. Application Data
(60) Provisional application No. 60/988,423, filed on Nov. 15, 2007.

(51) Int. Cl. G06K 7/06; A45C 11/00

(52) U.S. Cl. 235/441; 206/39

(57) ABSTRACT

The invention provides a case for holding a single card, with an opening in the front. A card can be inserted into the front opening until flush with the rear wall. Flexible tabs located on the back or sides of the case are deformed by the insertion of the card and this elastic deformation provides the retention force for keeping the card within the case in all orientations and use situations. The case is designed for wallet-sized cards. A clip may be attached to the case for mounting on a car visor, map pocket, or other location either within a vehicle or anywhere else desired. The clip is removable so that another means of attachment, such as hook and loop fasteners, double sided tape, adhesives or any other method may be used to attach the case to any desired location. The case may contain electronics and sensors for reading the card information, via magnetic strip, RFID or other method. An external surface of the case may contain a visual display for displaying information read from the card or otherwise gleaned from the card information (i.e. via remote connection with a system which can provide information on the card). The case may also contain one or more buttons on its surface for manually activating features, such as reading or display of the card information or interacting with a remote system. In addition, it may contain a speaker, microphone or other audio interface to allow a user to interface with the holder by voice command and audio responses. The electronics on the card holder may be able to communicate with a remote system via any non-contact information transfer method, such as RF communication using any number of standard methods (Bluetooth, Wi-Fi, etc.), ultrasonic, infrared visual transmission or any other system available. This connection may be used to obtain data from and send data to any remote system desired, so that purchase transactions, balance queries or other tasks may be performed in concert with an associated network, where, for example, balance information for the card account is stored or to accept or reject a transaction.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention is directed to the general use of all types of standard cash cards, debit cards, credit cards, gift cards and other standard wallet-sized cards for performing monetary transactions. The primary part of the invention is directed both to types of such cards which can store account balance information on the card, whether magnetically, chip based (i.e. RFID) or using other storage technology, as well as to cards which contain an account number whose balance information is stored on an external electronic network.

2. Description of the Related Art

Currently, there are many different methods of storing and locating wallet sized cards. However, most storage devices are not designed for fast, easy, convenient access in many possible locations, including within vehicles. Also, with most cash cards and gift cards, it is impossible to determine the balance remaining on the card account without first making a purchase or deposit to the account. This is of a particular concern when cards are used in vehicles for purchasing items at ‘Drive-Thru’ locations. If there is insufficient funds available in a card account, the user may not have available other means of payment. In addition, much time can be lost in a busy Drive-Thru by drivers searching for the location of their cash, debit or credit cards while attempting to drive up to the purchase window. For Drive-Thru owners, speed of service is paramount and lost time can mean significant monetary costs.

In particular, there are currently no devices which allow a card user to remotely access a POS network and determine card balances or perform transactions. Such a device would allow users to set up orders and complete transactions from within their vehicle, prior to reaching the Drive-Thru window—where all transactions now occur. This could result in significant time savings for all involved and also provide environmental benefits by reducing the amount of time vehicles spend idling in a Drive-Thru lineup.

Thus, there continues to be a need for a device which can not only store a wallet-sized card in a convenient location, either inside a vehicle, on a person or elsewhere, but is also able to interact with an electronic network to allow a person to check a card account balance prior to making a purchase. In addition, such a device could allow payments to be made automatically from within a vehicle, even at the time of ordering, without having to search for or even remove the card. This type of device could significantly reduce service times in Drive-Thru locations, resulting in cost savings.

### BRIEF SUMMARY OF THE INVENTION

The primary, general objective of this invention is to provide a card holder that stores wallet-sized cards easily in a convenient location and holds them in a manner that prevents rattling when used in locations where vibrations are present, such as within a vehicle.

The secondary, general objective is to provide a card holder that is capable of reading/writing to wallet-sized cash, debit or credit cards which are stored within it.

The tertiary, general objective is to provide a holder which can interface remotely to standard electronic networks to allow card balance information to be displayed or transactions to be performed without requiring removal of the card from the holder.

Another more specific objective is to provide a holder which can display information from the inserted card and any transaction information associated with transactions performed while the card is within the holder.

Another more specific objective is to provide a holder which has a user interface to allow transactions to be performed while the card is within the holder.

Another more specific objective is to provide a holder which does not require replacement of batteries, but uses the abundant sunlight available inside a vehicle windshield to provide power through solar cells.

Another more specific objective is to provide a holder which has a ‘hands free’ interface, that is through verbal commands and audible (spoken) feedback, to ensure that drivers are not distracted during use and to maximize safety.

A general goal is to keep the card from being misplaced, lost or damaged while stored.

Another objective is to provide a holder with the functionality described above which is compact and inexpensive to manufacture.

Still another objective is to provide a holder which can be easily mounted in almost any location using a number of flexible mounting methods.

Therefore, according to these and other objectives, the invention generally provides a compact, convenient device designed primarily for the storage of a wallet-sized card and for reading/writing to said card and remote interfacing with an electronic network in order to process transactions to the account associated with the card, while also allowing user input and displaying transaction results.

### BRIEF DESCRIPTION OF THE SEVERAL VIEWS OF THE DRAWING

FIG. 1 illustrates schematically a front perspective view of the first preferred embodiment of the invention.

FIG. 2 illustrates schematically a back perspective view of the first preferred embodiment of the invention.

FIG. 3 illustrates schematically a perspective view of the body of the case of the first preferred embodiment, in a disassembled configuration with all internal details shown.

FIG. 4 illustrates schematically a partially exploded back perspective view of the back piece and clip of the first preferred embodiment of the invention.

FIG. 5 illustrates schematically a cross section of the first preferred embodiment of the invention with a card shown in place.

FIG. 6 illustrates schematically front perspective view of the second preferred embodiment of the invention, which includes the optional electronics and associated details.

FIG. 7 illustrates schematically a perspective view of the body of the case of the second preferred embodiment, in a disassembled configuration with internal details and components shown.

### DETAILED DESCRIPTION OF THE INVENTION

The invention generally relates to a card holder that stores wallet-sized cards easily in a convenient location and holds them in a manner that prevents rattling. The first preferred embodiment describes such a device. A second embodiment is described which includes the optional electronics, card reader, visual display and human interface as described previously.

As used herein, the term “wallet-size cards” is meant to include any card, such as cash, debit, gift, credit, license, membership, access and other cards that are approximately 8.5 cm long by 5.5 cm wide and up to 1.5 mm thick. Of course, as would be obvious to one skilled in the art, the case of the invention may be made to dimensions that are suitable for carrying cards of other dimensions as well.

### First Preferred Embodiment

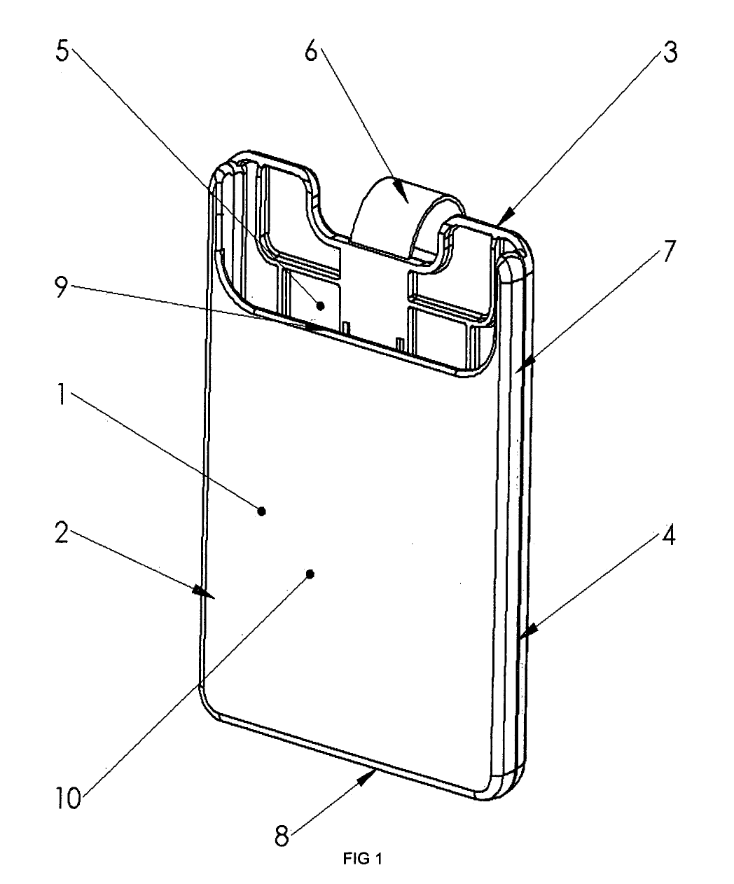

Referring to the drawings, wherein like parts are designated throughout with like numerals and symbols, FIG. 1 illustrates a front perspective view of the first preferred embodiment of the invention. In general, the body of the case 1 includes a front piece 2 and a back piece 3, joined together at seam 4, an opening 5 and a clip 6 attached to the back piece 3.

More specifically, the front piece 2 includes a front face 10, two side faces 7 and a lower face 8. A cutaway opening 9 in the front piece allows easier access to a card for insertion and removal. The front and back pieces are joined along the side faces 7 and lower face 8.

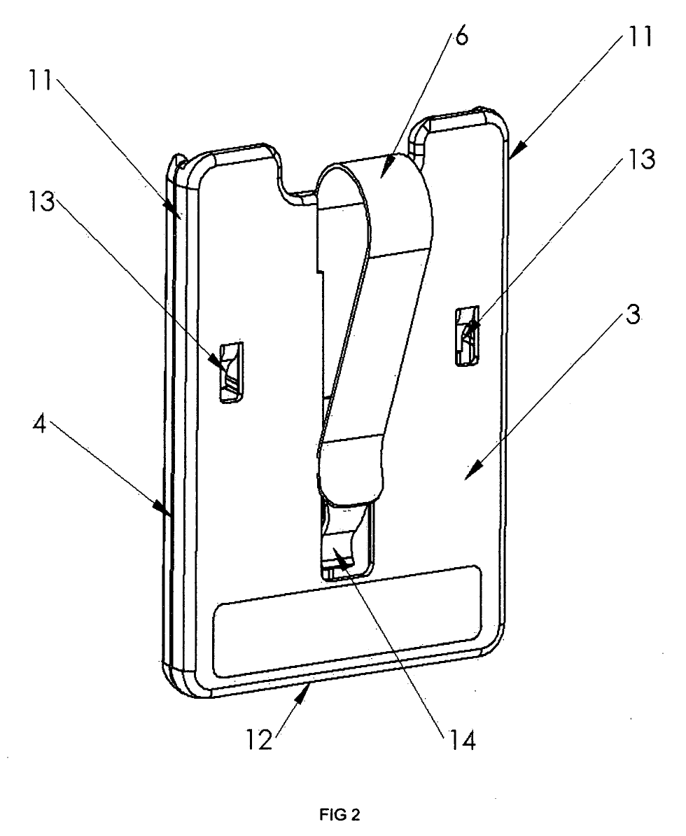

FIG. 2 illustrates a back perspective view of the case 1 with back piece 3 and clip 6 shown. The back piece also includes two side faces 11 and a lower face 12, along which the front and back pieces are joined by a seam 4. Preferably, the back piece 3 includes three integral tabs 13,14 which are part of the back piece 3. However, this design choice is not required as the tabs 13,14 may be attached as separate parts. This embodiment also shows a single, central larger tab 14 and two smaller tabs 13 located near the upper edges of the back piece 3. This orientation of the tabs 13,14 provides a statically stable force which maximizes vibration frequency, when combined with other features shown later. This is only one possible selection of tab numbers, sizes and locations and, as would be obvious to anyone skilled in the art, many other possible choices exist. However, the fundamental choice of having a plurality of tabs arranged such they provide a force distributed evenly across the card, in conjunction with the ribs shown below, maximizes the vibration frequency of the card when inserted in the holder, thereby minimizing or eliminating vibration and rattle of the card.

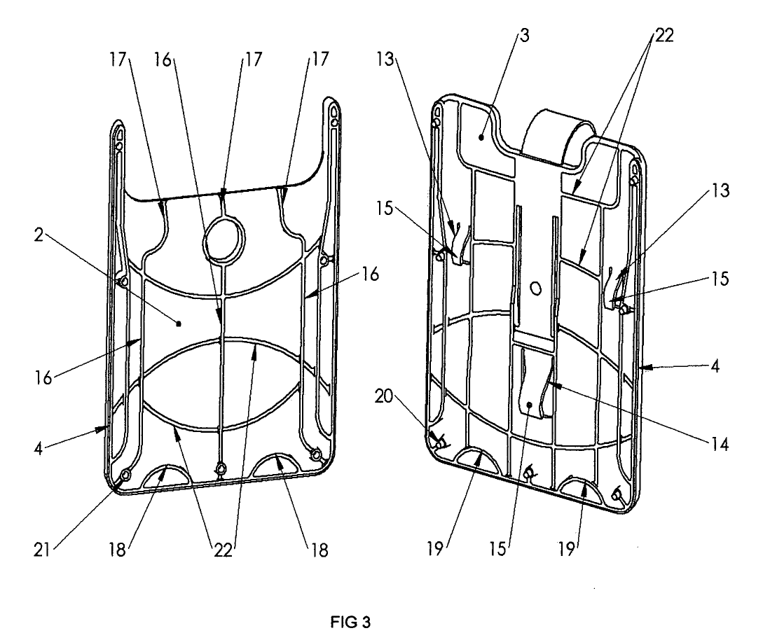

FIG. 3 illustrates schematically the body of the case disassembled, with the internal details of the front piece 2 and the back piece 3 shown. The internal faces 15 of the central tab 14 and upper tabs 13 are rounded and smooth to minimize marking of the card when inserted. There are three support ribs 16 located on the inside of the front piece 2 which are directly opposed to the tabs 13, 14. This positioning effectively squeezes the card once inserted and provides a very secure restraint which maximizes the natural frequency of the card, when designed in combination with tab 13,14 placement. The front (upper) edges 17 of the support ribs 16 are angled to create a smooth transition, allowing the card to be easily inserted and eliminating the need for exact alignment. End stops 18, 19 are located on the lower inside of both pieces and serve the purpose of fixing the maximum insertion depth of the card. These end stops are shown as semi-circular in shape. However, as would be obvious to one skilled in the art, they may be any shape desired. Posts 20 are located at the corners of the back piece 3 and corresponding holes 21 are located in the front piece 2. These are used for alignment when assembling the case. These may be used to hold the two halves by press fit, adhesive bonding, welding or any other methods. In addition, the two pieces may also be joined around the full periphery of the seam 4. Various other ribs 22 are located on the insides of both the front 2 and back 3 pieces. These are used for stiffening the case pieces, but, critically, must remain below the height of the tabs 13,14 or support ribs 16 in order to eliminate the possibility of rattling.

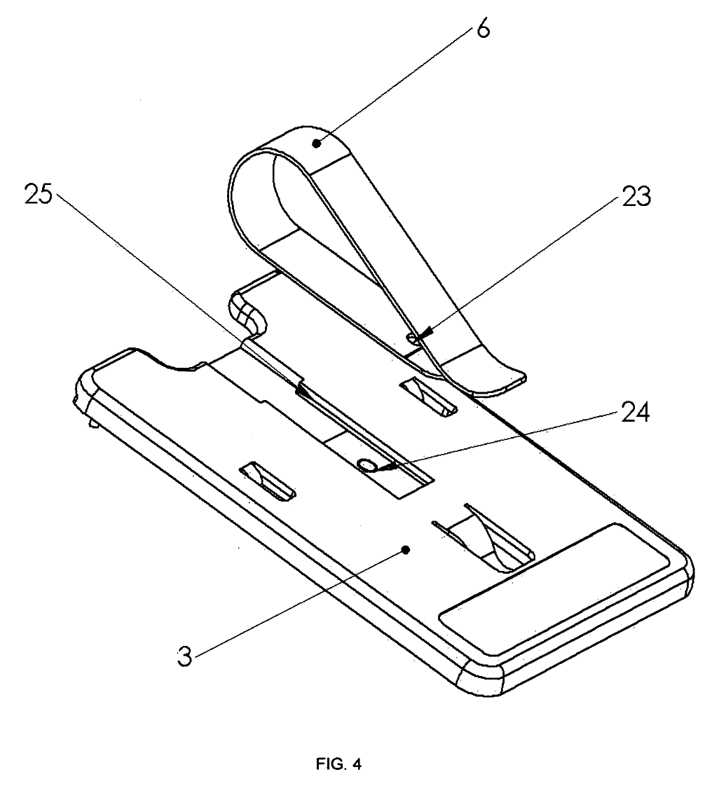

FIG. 4 illustrates schematically a partially exploded back view of the back piece 3 and clip 6. The clip 6 slides under overhangs 25 in the back surface of the back piece. A hole on the clip 23 is pushed up over a protrusion 24 in the back piece for retention.

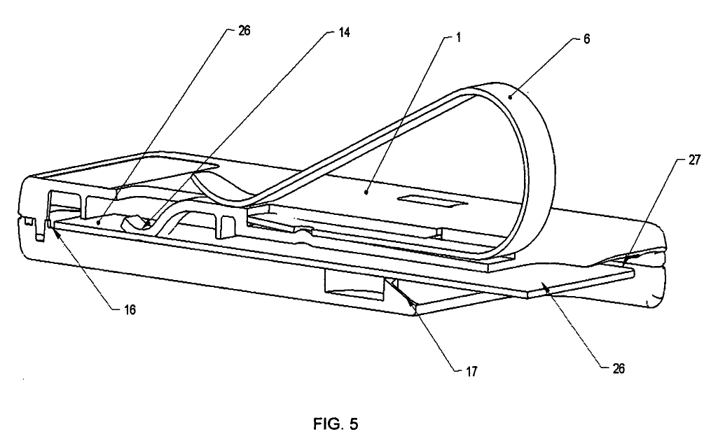

FIG. 5 illustrates a section view of the assembled holder 1 with a card 26 installed and retained between the central tab 14 and support rib 16. Also visible is the angled ramp 17 on the front of the central support rib 16, which facilitates card insertion. Also visible is the gap 27 on both sides of the card which prevent is from rattling on any component on either piece of the case.

### Second Preferred Embodiment

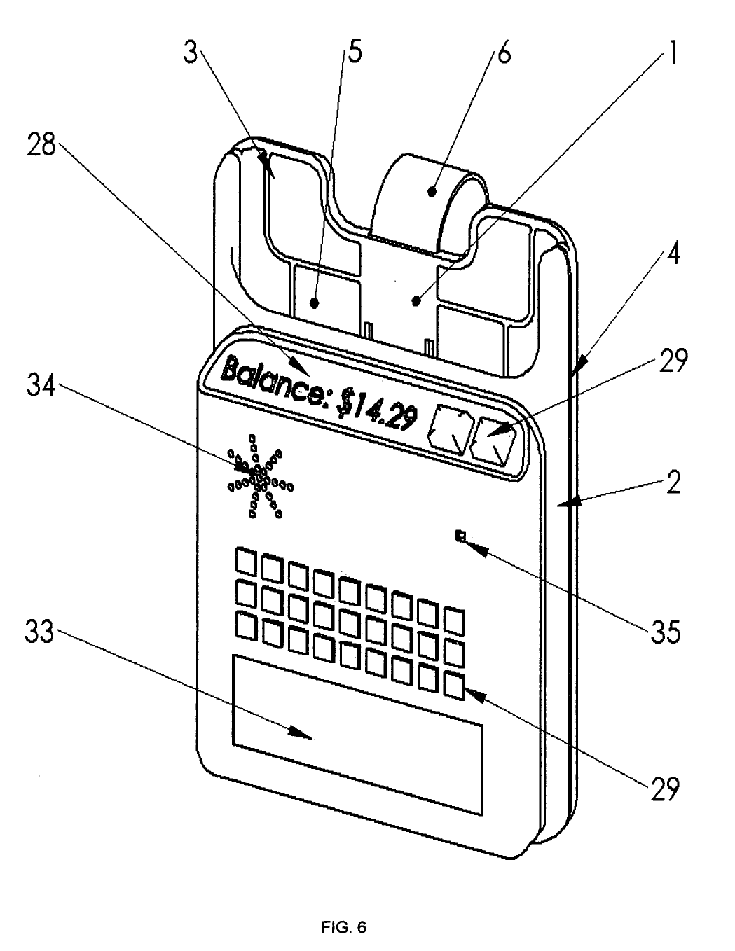

Referring to the drawings, wherein like parts are designated throughout with like numerals and symbols, FIG. 6 illustrates a front perspective view of the second preferred embodiment of the invention. In general, the body of the case 1 includes a front piece 2 with a visual display 28, human interface 29, speaker 34, microphone 35, solar cell 33 and a back piece 3, joined together at seam 4, an opening 5 and a clip 6 attached to the back piece 3. The second embodiment contains all the details described in the first embodiment of the holder with the addition of the electronics and associated items, which are described in this section.

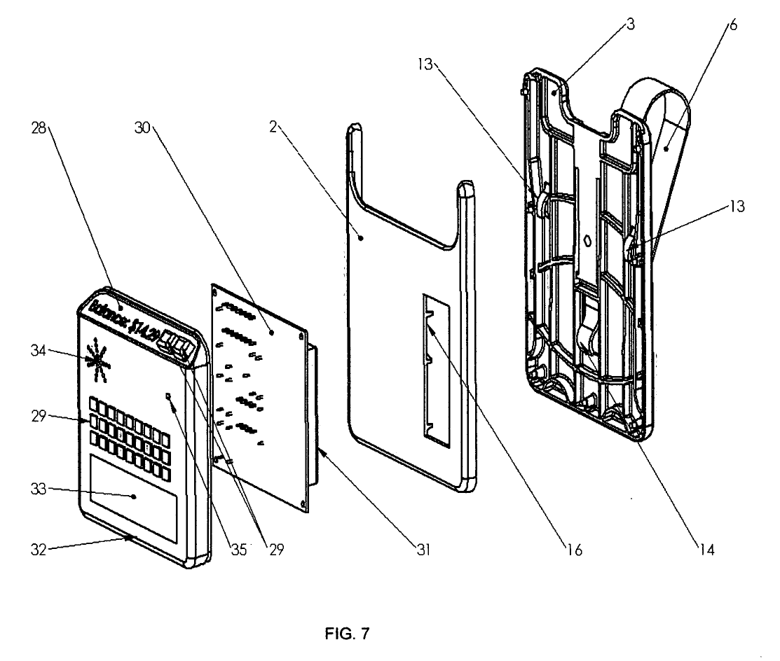

FIG. 7 illustrates schematically the body of the case in an exploded view with the front piece 2 on the left, back piece 3, clip 6, circuit board 30, card reader 31, visual display 28 and human interface 29. The circuit board 30 is shown mounted in the front piece 2, but may also be mounted in the back piece 3, providing other requirements are met. Note that the support ribs 16 are still present in the front piece 2, allowing the card to be squeezed against the tabs 13, 14 and held without vibration. This may necessitate the use of an extra front cover 32, shown in this embodiment, but does not require it. The human interface 29, visual display 28, speaker 34, microphone 35 and solar cell 33 may be alternately mounted on any convenient face of the case. In this embodiment, the human interface 29 is shown as two buttons and a keyboard, however, as is obvious to anyone skilled in the art, it could also be in the form of a touch pad, scroll wheel, switches, keyboard or any other type of human interface.

As would be recognized by one skilled in the art, the cases of the invention may be made of any moldable or castable material such as plastic, reinforced plastic, rubber, aluminum, stainless steel or other materials. Preferably, any such material used to manufacture the case pieces would have appropriate stiffness and strength to allow the retaining tabs to be made from one piece with the case.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent apparatus and procedures.

More specifically, the invention provides a three-dimensional, preferably flat and rectangular, case that contains an interior cavity defined by a top piece and a bottom piece, which each incorporate portions of side and end walls to enclose the cavity. Angled ribs are incorporated into one or more internal faces to guide the card into the retained position and to eliminate ‘rattling’ of the card caused by vibrations when used in a vehicle. One end wall has a partial or full opening to allow insertion of a standard wallet-sized card into the cavity. Optionally, the bottom face or side walls may also have a partial or full opening for ease of card insertion and removal, as the extra opening allows a portion of the card to be accessible by a person's fingers.

The card is retained in the holder by the means of flexible tabs which deform on card insertion and provide a frictional force to retain the card in all orientations and vibration environments. The flexible tabs push the card against opposing ribs on the opposite face, keeping it centered in the holder and away from other features, preventing it from rattling when used in environments where vibration is present (such as in a vehicle). The tabs may be incorporated into one of the holder pieces, or as separate parts assembled into the case. The number and placement of tabs is critical to the vibration eliminating feature of the product. The use of 3 separate tabs, one in the centre and 2 near the front edges, provides a stable, distributed force on the card. In combination with ribs which centre the card within the case and keep it away from the top and bottom faces and which directly oppose the tabs, the evenly distributed force increases the natural vibration frequency of the held card, thereby minimizing or eliminating altogether the possibility of the card being excited during driving at a vibration frequency near its natural frequency—which would result in rattling. Due to the annoying nature of rattling within vehicles, this feature is critical to the usability of this product. The thickness of the flexible tabs also plays an important role in the total retention force on the card. As is obvious to anyone skilled in the art, thicker tabs will provide more retention force and, in concert with tab placement, work to maximize natural vibration frequency. Obviously, there are many different possible locations and sizes/shapes for the flexible tabs which will provide a sufficient, stable force to maximize the natural vibration frequency and minimize vibrations, and the total force must be low enough for easy removal and insertion with a person's fingers alone, while working with any thickness of card for which the holder is designed to accommodate. The placement of the tabs is also optimized to eliminate them touching a magnetic strip on a card used in the holder. If the tabs were to touch the magnetic strip on a card, it is possible, after many insertion and removal cycles that the magnetic strip may be damaged, possibly causing loss of data and loss of funds by the card owner.

The outer back face of the case provides a slot feature to attach a metal or plastic mounting clip. This clip, when present, allows the holder to be mounted conveniently in many different places. Furthermore, the clip is removable, as it is retained by a small post on the back case part and a corresponding hole in the clip. This combination provides sufficient retention force to retain the clip against common loads during normal use, but can be overcome by a prying or transverse force (although one which may be applied with a person's hands) to allow the clip to be removed. This design allows for secure retention of the clip but also for user assisted removal if desired. If removed, the holder may be mounted in still further possible locations by the use of adhesives, tape, hook and loop fasteners, magnets or any other method of mounting which may be desired.

The front face of the case is flat and smooth to allow for the application of various types decoration which allows the holder to be used for advertising, branding or other uses.

Optionally, the case may contain one or more electronic circuit boards which perform various functions associated with reading and or writing to a card stored in the holder and communicating, by a wired or wireless method, with a standard electronic network for transferring data related to the card. The design of the circuit board(s) will be dependent on the exact type of card being used. For a magnetic strip card, a standard magnetic reader head is located either on the circuit board or within the case, to read the magnetic strip on a card as it is inserted. For an RFID type card, an RFID reader of the appropriate design to read a given card is located within the case or on the circuit board. The circuit board contains the electronics necessary to read and or write to the appropriate type of card, as well as any further circuitry, hardware, software or firmware necessary to perform other functions, as described in the following sections. The holder also contains a battery or other power source for the electronics contained within it.

Optionally, the circuit board may contain circuitry, hardware, software and firmware to allow the holder to communicate, either via wires or wirelessly using standard or custom methods, with a nearby electronic network upon which may be stored information regarding the balance on the card, transactions made using the card or other data regarding the card. Communication with said network allows the holder to perform transactions associated with the card, such as purchases, credits, balance requests and others. The circuitry, hardware and firmware incorporate all necessary security protocols in order to perform secure transactions with the network.

Optionally, the holder front outer face may contain a visual display and buttons, touch pads or other human interface devices to allow a person to view information regarding the card and interact with the holder or any electronic network to which it is communicating. This includes the ability to enter orders autonomously without a server or attendant, while still in the vehicle.

In addition, the holder may contain a speaker, microphone and circuitry and software to allow a user to interact with the holder and system verbally. This includes the ability to recognize voice commands and act on them (i.e. to place orders verbally) as well as the ability to return information audibly to the user. Such audible information may be in the form of beeps or other sounds used for confirmation or could be in the form of electronically generated speech which tells the user, for example, the card balance remaining or that a transaction has been completed. Obviously, many different possibilities for methods of interacting verbally and audibly with the holder and system are available and the description used herein does limit the possible methods which may be employed in any way. The primary purpose of a verbal and audible interface is to increase the safety of the user by preventing them from being distracted by requiring manual inputs and visual responses. The users will not be required to remove their attention from the task of driving (albeit slowly in a Drive-Thru) in order to interface with the holder and system.

The combination of the above features will allow a person to check the balance on their card and even perform payment or credit transactions without having to remove the card from the holder or from the vehicle. This can provide a significant time savings and also a major increase in convenience for in-vehicle card users.

Optionally, a solar power cell may be located on one external face of the case. This solar cell can be used alone or in combination with a battery or batteries, to provide power or recharge the electronic circuitry. This takes advantage of the large amount of sunlight generally available in vehicle windshields to maximize convenience to the user and to minimize environmental impact.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims. However, such drawings and description disclose but one of the various ways in which the invention may be practiced.

We claim:

1. A holder for a single wallet-sized card comprising:
A case, including a front piece and a back piece connected by two sidewalls and a rear wall, defining an interior cavity with an opening along one end of said case, where the opening may or may not continue on to further faces in order to provide ease of access;
One or more flexible tabs which are located on any face within the case and are deformed upon insertion of a card, providing a frictional force for retaining the card within the case, said tabs being designed and located in conjunction with opposing ribs to eliminate vibration of the card being held, to prevent rattling when used in locations where vibrations are present;

2. The holder of claim 1, further including a removable clip mounted on the case.

3. A holder for a single wallet-sized card comprising:
A case, including a front piece and a back piece connected by two sidewalls and a rear wall, defining an interior cavity with an opening along one end of said case, where the opening may or may not continue on to further faces in order to provide ease of access;
One or more flexible tabs which are located on any face within the case and are deformed upon insertion of a card, providing a frictional force for retaining the card within the case, said tabs being designed and located in conjunction with opposing ribs to eliminate vibration of the card being held, to prevent rattling when used in locations where vibrations are present;
A single, or a plurality of, electronic circuit board(s) which contain electronics and circuitry, firmware and software, including sensors, for reading and writing information from/to a wallet sized card mounted in the holder. This includes a battery, solar cell or other power source to provide power to the electronics.
A visual display system for displaying alphanumeric information, warning lights or other signals to the user located on an external face of the case.
A single or plurality of buttons or a keyboard accessible through an external face of the case, allowing the user to provide input or initiate commands to the electronics.
An audio speaker, microphone and associated circuitry and software to allow the user to provide verbal commands and receive audible responses.

4. The holder of claim 3, further including a wired or wireless communication system for communicating remotely with an electronic network in order to perform transactions and tasks related to the information stored on the card.

5. The holder of claim 3, further including a removable clip mounted on the case.

6. The holder of claim 4, further including a removable clip mounted on the case.
